(19) United States
(12) Patent Application Publication
(10) Pub. No.: US 2016/0255127 A1
(43) Pub. Date: Sep. 1, 2016

(54) Directing Meeting Entrants Based On Meeting Role

(71) Applicant: Microsoft Technology Licensing, LLC, Redmond, WA (US)

(72) Inventors: Gregory Paul Baribault, Sammamish, WA (US); Tolga Kilicli, Sammamish, WA (US)

(21) Appl. No.: 14/632,951

(22) Filed: Feb. 26, 2015

(51) Int. Cl. H04L 29/06; G06F 21/31; H04L 12/58

(52) U.S. Cl. CPC H04L 65/403; H04L 65/1069; H04L 65/1073; H04L 51/18; G06F 21/31; H04L 63/083

(57) ABSTRACT

In one or more embodiments, a meeting organizer develops a list that includes meeting participants and each participant's meeting role. Individual roles can have associated credentials that are utilized to sign into a particular meeting. A single invitation type is sent to all meeting participants irrespective of their role in the meeting. The invitation type includes a single join link for all participants. When a participant joins the meeting, they can be authenticated and authorized against the list that the organizer developed. Based on the participant's role, they are routed to the appropriate client application to consume the meeting.

### BACKGROUND

Online meetings can often include participants who serve different roles. For example, one role can be a production role in which an individual or individuals assigned to this role helps produce, in some manner, the meeting. This can include selecting different audiovisual equipment, mixing audio content, and the like. Other roles can include a speaker or presenter, moderator, camera operator, and the like. Yet other roles include attendees who may simply passively consume content of the meeting.

In the past, different meeting invitation types were sent to individuals based upon their roles. An invitation type, if accepted, would expose the acceptor to a particular type of experience based upon their role. For example, an individual serving in a production role might be exposed to an “inner meeting” experience in which they are able to openly communicate with other people serving in the production role. Individuals serving in an attendee role would not typically be exposed to the “inner meeting” experience. Rather, these individuals would be exposed to an experience in which they could passively consume content of the meeting and not be privy to communications taking place within the “inner meeting.”

One problem with this approach stemming from the different invitation types is that if an invitation type were to be forwarded by an individual serving in a production role to an individual serving in an attendee role, the attendee could then log into the meeting and be part of the “inner meeting.”

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more embodiments, a meeting organizer develops a list that includes meeting participants and each participant's meeting role. Individual roles can have associated credentials that are utilized to sign into a particular meeting. A single invitation type is sent to all meeting participants irrespective of their role in the meeting. The invitation type includes a single join link for all participants. When a participant joins the meeting, they can be authenticated and authorized against the list that the organizer developed. Based on the participant's role, they are routed to the appropriate client application to consume the meeting.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example computing device in accordance with one or more embodiments.

FIG. 2 is an illustration of an example environment in accordance with one or more embodiments.

FIG. 3 is an illustration of an example meeting invitation in accordance with one or more embodiments.

FIG. 4 is an illustration of an example authentication prompt in accordance with one or more embodiments.

FIG. 5 is a flow diagram that describes steps in a method in accordance with one or more embodiments.

FIG. 6 is a flow diagram that describes steps in a method in accordance with one or more embodiments.

FIG. 7 illustrates an example meeting room device that can be utilized to implement various embodiments described herein.

### DETAILED DESCRIPTION

Overview

In one or more embodiments, a meeting organizer develops a list that includes meeting participants and each participant's meeting role. Individual roles can have associated credentials that are utilized to sign into a particular meeting. A single invitation type is sent to all meeting participants irrespective of their role in the meeting. The invitation type includes a single join link for all participants. When a participant joins the meeting, they can be authenticated and authorized against the list that the organizer developed. Based on the participant's role, they are routed to the appropriate client application to consume the meeting.

In this manner, if a meeting invite is forwarded to an individual who does not have the appropriate credentials to sign into the meeting, they will be unable to sign into the meeting in the role associated with the invite. This enables more efficient control over who is permitted into a particular meeting and what role the admitted individual will serve.

In the following discussion, an example environment is first described that is operable to employ the techniques described herein. The techniques may be employed in the example environment, as well as in other environments.

Example Environment

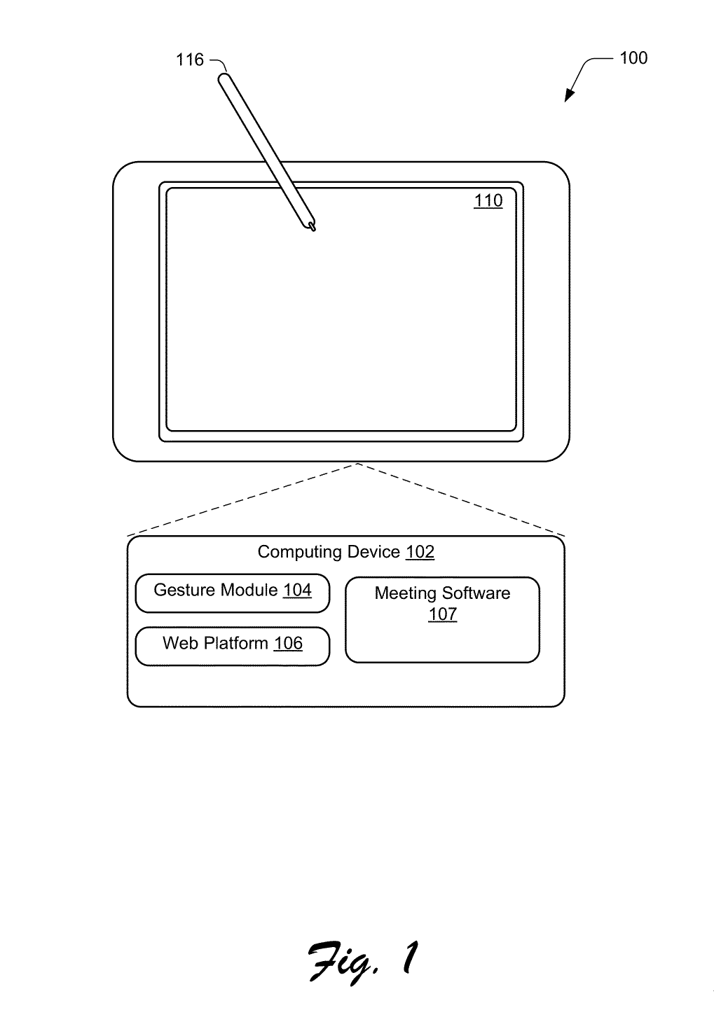

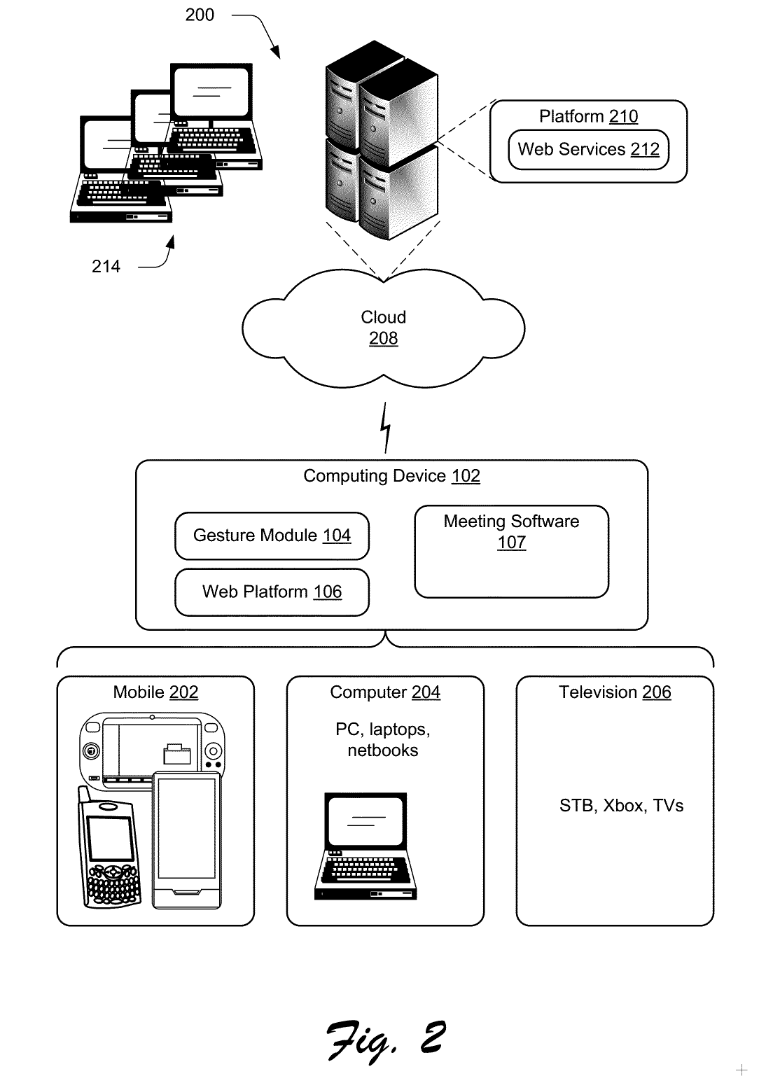

FIG. 1 is an illustration of an environment 100 in an example implementation that is operable to employ the techniques as described herein. The illustrated environment 100 includes an example of a computing device 102 that may be configured in a variety of ways. The computing device 102 may be configured as a traditional computer (e.g., a desktop personal computer, laptop computer, and so on), a mobile station, a wireless phone, a netbook, a handheld device, and so forth as further described in relation to FIG. 2. Thus, the computing device 102 may range from full resource devices with substantial memory and processor resources (e.g., personal computers) to a low-resource device with limited memory and/or processing resources. The computing device 102 also includes software that causes the computing device 102 to perform one or more operations as described below.

Computing device 102 can include, by way of example and not limitation, a number of different components including a gesture module 104, a web platform 106, and meeting software 107. The meeting software 107 can include any suitable type of software that enables a meeting to be planned and/or participated in.

The gesture module 104 is operational to provide gesture functionality. The gesture module 104 can be implemented in connection with any suitable type of hardware, software, firmware or combination thereof. In at least some embodiments, the gesture module 104 is implemented in software that resides on some type of computer-readable storage medium examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand as proximal to display device 110 of the meeting room device 102 using touchscreen functionality.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand) and a stylus or pen input (e.g., provided by a stylus 116). The differentiation may be performed in a variety of ways, such as by detecting an amount of the display device 110 that is contacted by the finger of the user's hand versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

Meeting software 107 is representative of software that enables meetings to be planned and/or conducted using various features which can include, by way of example and not limitation, instant messaging, Voice over IP, video conferencing, and the like.

FIG. 2 illustrates an example system 200 showing the components of FIG. 1, e.g., meeting software 107, as being implemented in an environment where multiple devices are interconnected through a central computing device. The meeting software 107 can enable meetings to be conducted using various features which can include, by way of example and not limitation, instant messaging, Voice over IP, video conferencing, content sharing and the like.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, tablets, large form factor devices, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on. One web service that can be provided as part of Web services 212 includes a meeting service. The meeting service can enable online meetings to be conducted and can include, by way of example and not limitation, a join service which serves to enable different meeting participants to join a meeting and be directed to the appropriate meeting experience based upon their role, as will be discussed below in more detail.

Thus, the cloud 208 is included as a part of the strategy that pertains to software and hardware resources that are made available to the computing device 102 via the Internet or other networks. For example, aspects of the meeting software 107 may be implemented in part on the computing device 102 as well as in a distributed fashion via platform 210 that supports web services 212 (e.g., the join service).

In addition, system 200 can include one or more remote computing devices 214 associated with remote participants who can participate in a meeting organized and conducted through computing device 102. Each of the remote computing devices 214 can execute a meeting client that enables communication with meeting software 107.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Role Based Meeting Entrant Direction” describes how a meeting entrant or participant can be directed based upon their role in a particular meeting, in accordance with one or more embodiments. Next, a section entitled “Modifying Participant Roles” describes how participant roles can be modified in real time during the pendency of a meeting in accordance with one or more embodiments. Following this, a section entitled “Closed Meetings and Open Meetings” describes various differences in the re-direction functionality in accordance with whether a meeting is open or closed. Last, a section entitled “Example Device” describes aspects of an example device that can be utilized to implement one or more embodiments.

Having considered an example operating environment, consider now a discussion of how meeting entrants can be directed based on their role in the meeting.

Role Based Meeting Entrant Direction

In one or more embodiments, a meeting organizer develops a list that includes meeting participants and each participant's meeting role. Meeting roles can be assigned using any suitable type of assignment mechanism. In the example described below, meeting roles are assigned based upon whether a participant as part of a so-called “event team” or is an “attendee.”

Event teams include participants who have specific roles within a particular meeting. The specific roles can include, by way of example and not limitation, production roles, speakers, remote producers, camera assistance or controllers, and the like. In some scenarios, the event team is a small but select group of individuals who are charged with orchestrating or driving the meeting itself. Orchestration of the meeting can be considered to take place through a so-called “inner meeting.” The inner meeting enables the event team to communicate amongst themselves in a manner in which the attendees are not privy. The inner meeting can take place by way of a suitably-configured client application that permits communication amongst the event team, e.g., instant messaging, content sharing, and the like.

Attendees are typically the general population of people who are attending an online meeting. In some instances, attendees can be considered to attend an “outer meeting” which is different from the “inner meeting.” The outer meeting is not privy to much if any of the communication that takes place in the inner meeting.

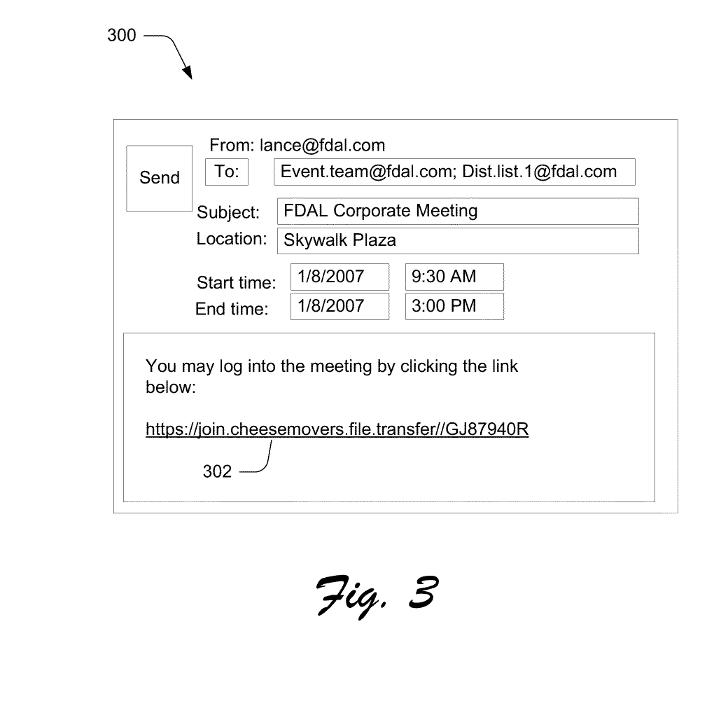

Individual roles, such as the event team and the attendees, can have associated credentials that are utilized to sign into a particular meeting. A single invitation type is sent to all meeting participants irrespective of their role in the meeting. Thus, all participants get invited to what appears to be the same event. In one or more embodiments, the invitation type includes a single join link, such as a URL, for all participants. So, rather than trying to manage two or more different invitation types, one for the event team and the other for the attendees, a single invitation type is utilized to manage the meeting. As an example, consider FIG. 3.

There, a single invitation type is shown generally at 300. The invitation type is addressed to two different recipient groups—the event team (Event.team@fdal.com”) and the attendees (“Dist.list.1@fdal.com”). A single join link is provided in the invitation and is shown generally at 302. Thus, participants having different roles can join the meeting by way of a single join link.

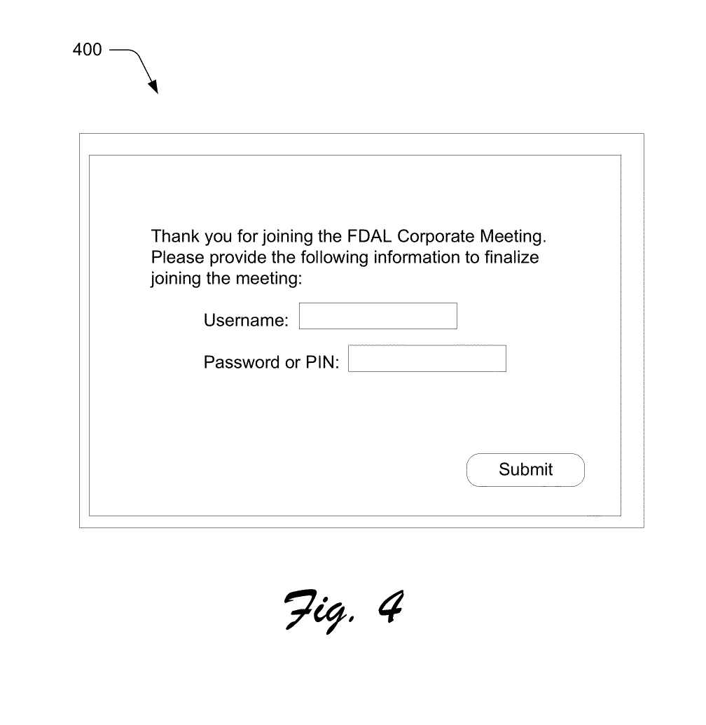

When a participant joins the meeting, as by clicking on the join link, a join service can authenticate the participant and authorize them against the list that the organizer developed. As an example, consider FIG. 4.

There, when the participant clicks the single join link, they are presented with a window or join prompt such as the one shown generally at 400. This window enables the participant to finalize joining the meeting. In this particular example, the participant can provide a user name and a password or PIN. Once authenticated, the participant can be authorized against the pre-defined list that the organizer developed and, based on their role, can be routed to the appropriate client application to consume the meeting.

In at least some embodiments and in this particular example, participants on the event team can be routed to a meeting client such as Lync client. Likewise, participants who are not on the event team, such as the attendees, can be routed to a different client application such as a web client.

Having considered the various embodiments above, consider now example methods in accordance with one or more embodiments.

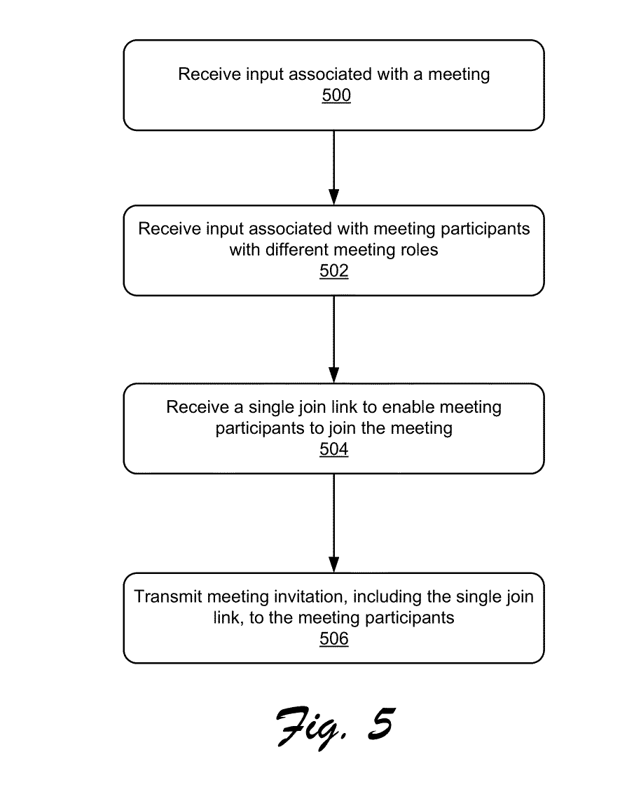

FIG. 5 is a flow diagram that describes steps in a method in accordance with one or more embodiments. The method can be implemented in connection with any suitable hardware, software, firmware, or combination thereof. In at least some embodiments, the method is implemented by a suitably-configured software application, such as a calendar application, that is configured to enable meetings to be organized.

Step 500 receives input associated with a meeting. This step can be performed in any suitable way. For example, this step can be performed by receiving information including a date, time, and location for the meeting. Step 502 receives input associated with meeting participants with different meeting roles. Any suitable number of participants and any suitable number of meeting roles can be utilized. In the example above, two different meeting roles are utilized—that of the event team and the attendees. Step 504 receives a single join link to enable meeting participants to join the meeting. This single join link can be used by each participant irrespective of their role in the meeting. Step 506 transmits a meeting invitation, including the single join link, to the meeting participants. As noted above, the single join link enables each participant, irrespective of their role, to join the meeting. In this manner, a single invitation type is utilized and avoids the need to use two or more different types of invitations depending on a participant's role.

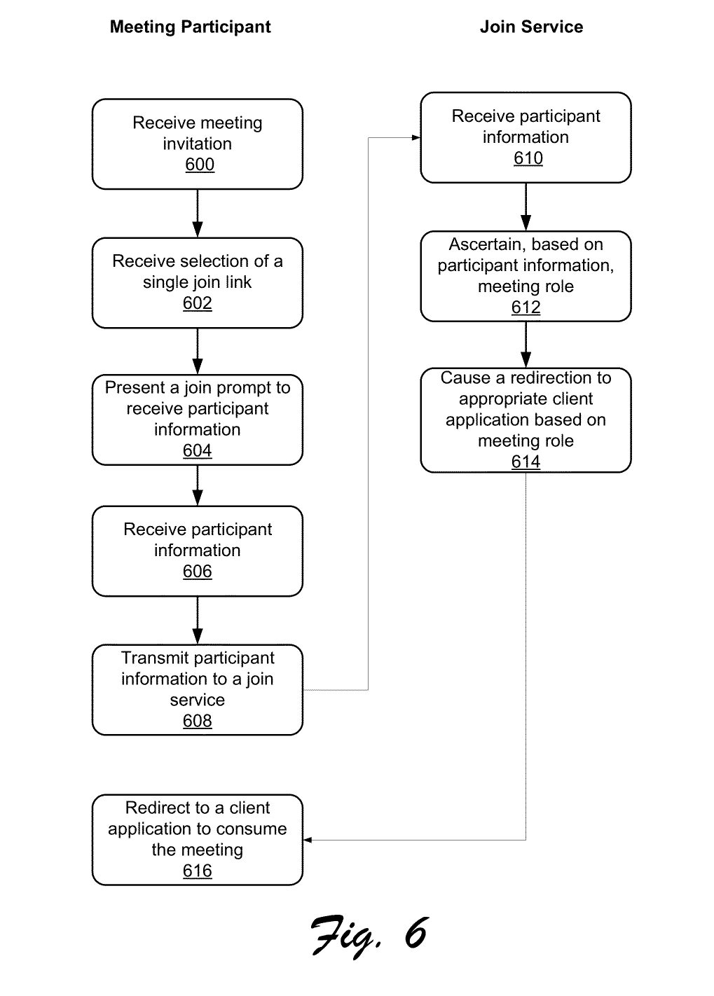

FIG. 6 is a flow diagram that describes steps in a method in accordance with one or more embodiments. The method can be implemented in connection with any suitable hardware, software, firmware, or combination thereof. In at least some embodiments, aspects of the method can be implemented by a suitably-configured software application that is configured to enable a participant to join a meeting. These aspects appear under the heading “Meeting Participant.” Other aspects of the method can be performed by a suitably-configured join service such as that described above. These aspects appear under the heading “Join Service.”

Step 600 receives a meeting invitation. In the illustrated and described embodiment, the meeting invitation includes information associated with the meeting such as the time and place, as well as a single join link. Step 602 receives selection of the single join link. This step can be performed in any suitable way including, by way of example and not limitation, through a mouse input, touch input, gesture, and the like. Step 604 presents a join prompt to receive participant information. One example of a join prompt is described above in relation to FIG. 4. Step 606 receives participant information using the join prompt. Any suitable type of participant information can be received including, by way of example and not limitation, the user name, password, PIN, and the like. Step 608 transmits the participant information to a join service.

Step 610 receives, at the join service, the participant information. Step 612 ascertains, based on the participant information, a meeting role associated with the participant. This step can be performed in any suitable way. For example, the join service can utilize the participant information, such as the username or PIN, to cross-reference a list that describes the individual participants and their associated roles. Once the join service has ascertained the role associated with the participant, the join service can cause, at step 614, a redirection to an appropriate client application based on the meeting role. In the above example, if a participant is a member of the event team, their computing device can be redirected to a meeting client such as a Lync client. Alternately, if the participant is a member of the attendees, their computing device can be redirected to a web client to enable them to consume the meeting. Accordingly, step 616 redirects the participant's computing device to a client application to enable them to consume the meeting.

Having considered example methods in accordance with one or more embodiments, consider now how participant roles can be dynamically modified in real time during the pendency of the meeting.

Modifying Participants Roles

In one or more embodiments, the rules of participants can be modified dynamically in real-time during the pendency of the meeting. For example, in the list that is maintained by the join service, a participant may have their role changed from event team to attendee. This may be in response to the participant having been mistakenly categorized as an event team member or for other reasons. In this instance, the participant can be prompted to rejoin the meeting by selecting the single join link to undergo the process described just above.

Having considered how participant roles can be modified in real-time during dependency of the meeting, consider now the notion of closed meetings and open meetings and how role-based meeting direction can take place.

Closed Meetings and Open Meetings

In the illustrated and described embodiments, a closed meeting is a meeting in which all participants are authenticated and then authorized against the list prepared by the meeting organizer. If an individual is not invited to a particular meeting, they are not allowed into the meeting. The example provided above is an example of a closed meeting. An open meeting, on the other hand, allows any participant with access to the join link to join the meeting. In this manner, the meeting is open in that it is effectively anonymous.

In an open meeting scenario, when a participant clicks on the join link, they are prompted by the join service for their meeting role. Thus, if a participant believes that they are a producer or speaker, they can indicate that to the join service. Once the participant indicates their role, they can be authenticated, as appropriate, to prove that they are in fact who they say they are. This can be done in a manner similar to that described above, as by the participant entering a username, password, PIN, and the like. Once authenticated and authorized, the participant can be redirected to the appropriate meeting client. If, on the other hand, the participant is an attendee, they can be redirected to the appropriate client application such as, for example, an attendee webpage. In this instance, no authentication is necessary because the meeting is an open meeting and the participant indicated that they were an attendee.

Having considered the various embodiments described above, consider now an example computing device that can be utilized to implement one or more of the embodiments described above.

Example Computing Device

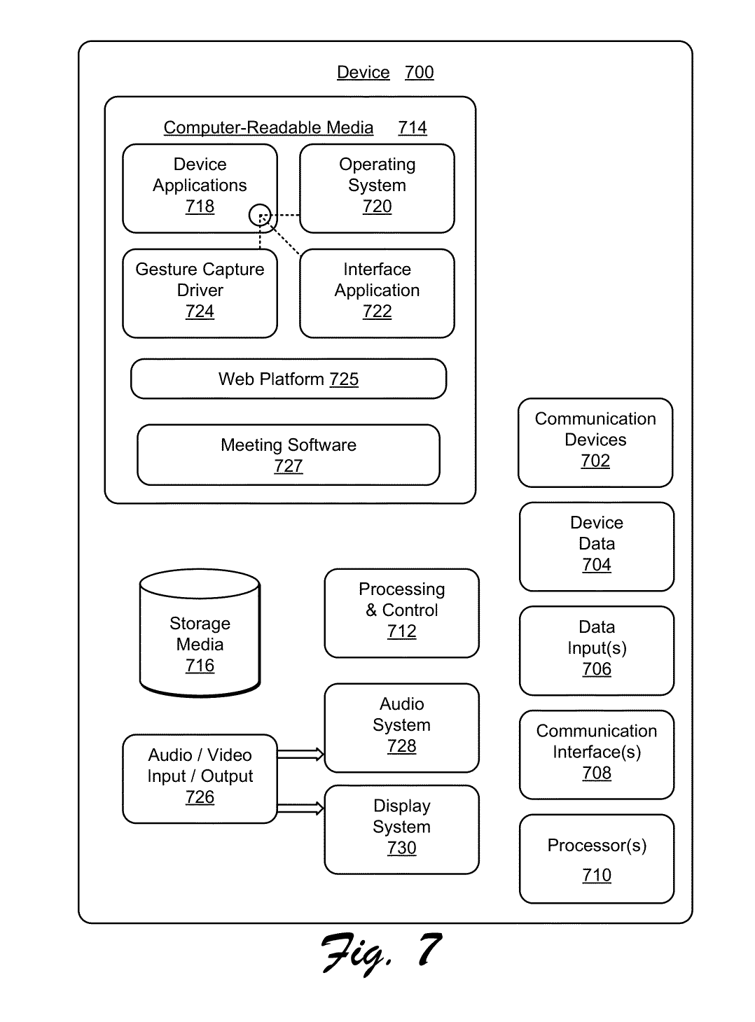

FIG. 7 illustrates various components of an example computing device 700 that can be implemented as any type of computing device as described with reference to FIGS. 1 and 2 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700, such as in the context of the meeting.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and a gesture capture driver 724 that are shown as software modules and/or computer applications. The gesture capture driver 724 is representative of software that is used to provide an interface with a device configured to capture a gesture, such as a touchscreen, track pad, camera, and so on. Alternatively or in addition, the interface application 722 and the gesture capture driver 724 can be implemented as hardware, software, firmware, or any combination thereof. Additionally, computer readable media 714 can include a web platform 725 and meeting software 727 that functions as described above.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### EXAMPLE IMPLEMENTATIONS

Example implementations employing a meeting summary described herein include, but are not limited to, one or any combination of one or more of the following example:

A computer-implemented method comprising: receiving input associated with a meeting; receiving input associated with meeting participants having different meeting roles; receiving a single join link configured to enable meeting participants to join the meeting and be redirected to one of multiple different client applications that enable performance of a participant's role; and transmitting a meeting invitation, including the input associated with the meeting, the input associated with the meeting participants and the single join link, to the meeting participants to enable each participant to join the meeting by way of the single join link.

A method as described above, wherein said receiving input associated with meeting participants comprises receiving input associated with meeting attendees and participants other than meeting attendees.

A method as described above, wherein the single join link is configured to enable participants to be authenticated and authorized for a role against a pre-defined list.

A method as described above, wherein the meeting roles comprise an event team and attendees.

A method as described above, wherein said transmitting a meeting invitation comprises transmitting an e-mail.

A method as described above, wherein the single join link is configured to redirect meeting attendees to a web client application and other meeting participants to a different client application.

A method as described above, wherein the single join link is configured to redirect meeting attendees to a web client application and other meeting participants to a meeting client application that permits communication between said other meeting participants.

A system comprising: one or more processors; one or more computer readable media; computer readable instructions stored on the one or more computer readable media which, when executed by the one or more processors, perform operations comprising: receiving a meeting invitation including a single join link configured to enable meeting participants to join a meeting and be redirected to one of multiple different client applications that enable performance of a participant's role; receiving selection of the single join link; presenting a join prompt to receive participant information; receiving participant information using the join prompt; transmitting the participant information to a join service to enable the join service to allow a participant to join the meeting; and receiving a redirection from the join service effective to redirect a participant's computing device to one of multiple different client applications that enable a participant to consume the meeting and perform their role.

A system as described above, wherein the participant information comprises one or more of a user name or password.

A system as described above, wherein the participant information comprises a PIN.

A system as described above, wherein the multiple different client applications comprise a meeting client application or a web client application redirection to which is based on a participant's role.

A system as described above, wherein receiving a meeting invitation comprises receiving an e-mail.

A system as described above, wherein one of the multiple different client applications comprises a web client application for meeting attendees, and a different client application for participants other than meeting attendees.

A system as described above, wherein one of the multiple different client applications comprises a web client application for meeting attendees and a meeting client application for participants other than attendees.

A system as described above, wherein the meeting is an open meeting.

A system comprising: one or more processors; one or more computer readable media; computer readable instructions stored on the one or more computer readable media which, when executed by the one or more processors, perform operations comprising: receiving, at a join service, participant information associated with participants attempting to join a meeting, the participant information having been transmitted to the join service in connection with a single join link that is configured to enable meeting participants to join a meeting and be redirected to one of multiple client applications that enable performance of a participant's role; ascertaining, based on the participant information, a meeting role associated with the participant; and causing redirection of a participant's computing device to an appropriate client application based on the participant's meeting role.

A system as described above, wherein said ascertaining is performed by using the participant information to cross-reference a list that describes participants and associated roles.

A system as described above, wherein said causing comprises causing redirection to a meeting client application or a web client application based on a participant's meeting role.

A system as described above, wherein said causing comprises causing redirection of meeting attendees to a web client application and causing redirection of participants other than meeting attendees to a client application other than a web client application.

A system as described above, wherein said causing comprises causing redirection of meeting attendees to a web client application and causing redirection of participants other than meeting attendees to a meeting client application that permits communication between the other meeting attendees.

### CONCLUSION

In one or more embodiments, a meeting organizer develops a list that includes meeting participants and each participant's meeting role. Individual roles can have associated credentials that are utilized to sign into a particular meeting. A single invitation type is sent to all meeting participants irrespective of their role in the meeting. The invitation type includes a single join link for all participants. When a participant joins the meeting, they can be authenticated and authorized against the list that the organizer developed. Based on the participant's role, they are routed to the appropriate client application to consume the meeting.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
receiving input associated with a meeting;
receiving input associated with meeting participants having different meeting roles;
receiving a single join link configured to enable meeting participants to join the meeting and be redirected to one of multiple different client applications that enable performance of a participant's role; and
transmitting a meeting invitation, including the input associated with the meeting, the input associated with the meeting participants and the single join link, to the meeting participants to enable each participant to join the meeting by way of the single join link.

2. The method of claim 1, wherein said receiving input associated with meeting participants comprises receiving input associated with meeting attendees and participants other than meeting attendees.

3. The method of claim 1, wherein the single join link is configured to enable participants to be authenticated and authorized for a role against a pre-defined list.

4. The method of claim 1, wherein the meeting roles comprise an event team and attendees.

5. The method of claim 1, wherein said transmitting a meeting invitation comprises transmitting an e-mail.

6. The method of claim 1, wherein the single join link is configured to redirect meeting attendees to a web client application and other meeting participants to a different client application.

7. The method of claim 1, wherein the single join link is configured to redirect meeting attendees to a web client application and other meeting participants to a meeting client application that permits communication between said other meeting participants.

8. A system comprising:
one or more processors;
one or more computer readable media;
computer readable instructions stored on the one or more computer readable media which, when executed by the one or more processors, perform operations comprising:
receiving a meeting invitation including a single join link configured to enable meeting participants to join a meeting and be redirected to one of multiple different client applications that enable performance of a participant's role;
receiving selection of the single join link;
presenting a join prompt to receive participant information;
receiving participant information using the join prompt;
transmitting the participant information to a join service to enable the join service to allow a participant to join the meeting; and
receiving a redirection from the join service effective to redirect a participant's computing device to one of multiple different client applications that enable a participant to consume the meeting and perform their role.

9. The system of claim 8, wherein the participant information comprises one or more of a user name or password.

10. The system of claim 8, wherein the participant information comprises a PIN.

11. The system of claim 8, wherein the multiple different client applications comprise a meeting client application or a web client application redirection to which is based on a participant's role.

12. The system of claim 8, wherein receiving a meeting invitation comprises receiving an e-mail.

13. The system of claim 8, wherein one of the multiple different client applications comprises a web client application for meeting attendees, and a different client application for participants other than meeting attendees.

14. The system of claim 8, wherein one of the multiple different client applications comprises a web client application for meeting attendees and a meeting client application for participants other than attendees.

15. The system of claim 8, wherein the meeting is an open meeting.

16. A system comprising:
one or more processors;
one or more computer readable media;
computer readable instructions stored on the one or more computer readable media which, when executed by the one or more processors, perform operations comprising:
receiving, at a join service, participant information associated with participants attempting to join a meeting, the participant information having been transmitted to the join service in connection with a single join link that is configured to enable meeting participants to join a meeting and be redirected to one of multiple client applications that enable performance of a participant's role;
ascertaining, based on the participant information, a meeting role associated with the participant; and
causing redirection of a participant's computing device to an appropriate client application based on the participant's meeting role.

17. The system of claim 16, wherein said ascertaining is performed by using the participant information to cross-reference a list that describes participants and associated roles.

18. The system of claim 16, wherein said causing comprises causing redirection to a meeting client application or a web client application based on a participant's meeting role.

19. The system of claim 16, wherein said causing comprises causing redirection of meeting attendees to a web client application and causing redirection of participants other than meeting attendees to a client application other than a web client application.

20. The system of claim 16, wherein said causing comprises causing redirection of meeting attendees to a web client application and causing redirection of participants other than meeting attendees to a meeting client application that permits communication between the other meeting attendees.
